(19) United States
(12) Patent Application Publication
(10) Pub. No.: US 2004/0260035 A1
(43) Pub. Date: Dec. 23, 2004

(54) Crystallizable thermoplastic resins and dendrimers with improved fabrication characteristics

(76) Inventors: Issam Dairanieh, Naperville, IL (US); Donald E. Rubis, Somonauk, IL (US)

Correspondence Address: BP America Inc., Docket Clerk, BP Legal, M. C. 5East, 4101 Winfield Road, Warrenville, IL, 60555, US

(21) Appl. No.: 10/864,018

(22) Filed: Jun. 9, 2004

Related U.S. Application Data
(60) Provisional application No. 60/477,731, filed on Jun. 11, 2003.

(51) Int. Cl. C08L 67/00

(52) U.S. Cl. 525/437

(57) ABSTRACT

The strain-hardening characteristics and melt rheology of thermoplastic resins including crystallizable polyester resins are modified by blending with a dendrimeric modifier. Blends comprising PET resins and up to about 2 wt. % of a dendrimer have increased melt strengths and exhibit a reduction in strain-hardening parameter, reflected in a lower strain level at the onset of strain hardening. Blends further comprise PET resins and a component comprising a ratio of dendrimer modifier to purified terephthalic acid.

### CROSS REFERENCE TO RELATED APPLICATIONS

This application claims the benefit of U.S. Provisional Patent Application Ser. No. 60/477,731 filed on Jun. 11, 2003.

### BACKGROUND OF THE INVENTION

This invention relates generally to thermoplastic resins, more particularly to crystallizable thermoplastic resins such as polyester resins with improved fabrication characteristics, and still more particularly to a method for modifying the strain-hardening characteristics, melt strength and melt rheology of thermoplastic resins such as crystallizable polyester resins. The invention may be further characterized as being directed to compositions that exhibit modified strain-hardening characteristics and improved melt strength, said compositions preferably comprising polyethylene terephthalate (PET) resin and a dendrimeric modifier.

The level of crystallinity substantially affects the mechanical properties of crystallizable thermoplastics such as, for example, polyethylene terephthalate (PET). Amorphous PET generally has low strength properties and poor barrier properties. Stretching and orienting a substantially amorphous resin article, whether done uniaxially or, preferably, biaxially, i.e., along two orthogonal axes, provides nucleation sites from which typical crystal regions propagate in an ordered fashion. As the material is oriented and/or crystallized, strength and modulus properties are increased. Highly oriented resins also have substantially improved gas barrier properties.

The gas and vapor barrier properties of plastic materials are an important consideration in the packaging industry. The rate at which carbon dioxide, CO₂, will escape from bottles containing carbonated drinks will determine whether the beverage will go flat on the shelf before it can be sold and used by the consumer. The rate of ingress of oxygen from the atmosphere into the product container is also important to beverage bottlers and to those who package other food products such as cookies, meat, candy and similar products. The rate of water vapor transmission through package walls can affect the freshness of a variety of packaged foods. While at the present time there are PET resins which can be used in the bottling and wrapping markets, further improvements are desirable.

More recently, PET copolymer resins have been disclosed for use in a variety of packaging applications. PETI copolymer resins comprising ethylene terephthalate and up to about 20% ethylene isophthalate are disclosed in the art to have improved barrier properties, as are PETN copolymers comprising ethylene naphthalate units. Such resins, and methods for their production and fabrication, are widely known and well described in the art, for example, in U.S. Pat. Nos. 5,646,208, 6,485,804, 6,335,422 and 6,150,454, the teachings of which are incorporated herein by reference.

Although the barrier properties of PET resins may be improved by incorporating comonomers, other properties may be detrimentally affected by the modification. For example, the thermal crystallization rate of PETI resins containing 10 mole % ethylene isophthalate is slower than for PET or for PETI packaging resins comprising low levels, e.g., 2.5 mole % of ethylene isophthalate. The slow crystallization rate requires using lengthened processing cycle, which decreases output and increases production costs. In addition, blow molded bottles fabricated from these copolymer resins may have less crystallinity in the less stressed regions, for example, in the neck and base of the bottle. Consequently, the barrier properties in the less stressed areas will be reduced, thereby increasing the rate of escape of the contained gases, for example, CO₂.

Packaging resins must be stretched to their natural draw ratio in order to achieve the degree of strain hardening required to give the package walls acceptable physical characteristics and barrier performance. Articles comprising a resin having a high natural draw ratio require greater extension—higher strain—to adequately orient and crystallize the resin. The effect may be quantified by plotting stress vs. strain data obtained in tensile testing of materials. For PET, stress-strain curves typically comprise a plurality of segments. Initially, the stress-strain line rises almost linearly to the yield point—the stress level where yield begins. Beyond the yield point, the stress level remains nearly constant as strain increases, the test specimen or article being stretched through chain unfolding and alignment, thereby orienting the chains; as strain further increases the oriented chains undergo crystallization, causing a rapid increase in stress level, which identifies the strain-hardening region. The point at which strain-hardening becomes apparent, i.e., when a sharp increase in stress level occurs, may be taken as the strain-hardening point (SHP).

Typically, PET tooling is designed to an areal strain (axial draw ratio times radial draw ratio) of 11-13. Modifying PET with comonomers such as PIA or NDC-increases the natural draw ratio (NDR) relative to PET, and the NDR increases significantly at higher levels of comonomer. Modifying PET by replacing 10% of its terephthalic acid with PIA or NDC leads to an areal strain of from about 18 to about 20, while a 20% modification leads to an areal strain in the range of from about 33 to about 36. To achieve these high values, shorter and thicker preforms are employed, thus requiring longer heat transfer times (cooling or heating). This requires an increase in cycle time and redesign of existing PET tooling, which translate into higher costs and limits the acceptance of copolyesters by the trade.

Moreover, operating the two-stage, high output, reheat blow molding machines that are widely employed commercially for producing PET resin articles at reduced throughput in order to extend cycle times and properly heat the preforms may cause substantial reduction in productivity.

Methods disclosed in the art for modifying the natural draw ratio of resins have generally been directed to increasing the resin molecular weight, for example, by solid-state polymerization or by incorporating triols, tetracarboxylic acids or other compounds having a plurality of functional groups that will undergo transesterification, thereby serving as branching agents. Low molecular weight polymers, hyperbranched polymers and dendrimers having a plurality of reactive terminal groups have also been disclosed in the art for use as a crosslinking agent in a variety of resins. Although the use of branching agents as disclosed in the art, for example, in U.S. Pat. No. 6,150,454, does increase molecular weight there is a concomitant increase in melt viscosity that requires use of increased processing temperatures, leading to thermal decomposition. In addition, polyfunctional additives tend to cause gel formation and, depending upon the level employed, may crosslink and thermoset the resin.

A method for modifying the strain-hardening characteristics of polyesters without significantly increasing the resin melt viscosity would be particularly useful in providing moldable PET copolymer resin compositions having a natural draw ratio near that of PET.

### SUMMARY OF THE INVENTION

The invention is directed to thermoplastic compositions having modified strain-hardening characteristics and to methods for reducing the natural draw ratio of thermoplastic resins without significantly raising the melt viscosity. The compositions of this invention will comprise a thermoplastic, preferably a polyester and a dendrimeric modifier, more particularly a hyperbranched polymer or a dendrimer. Polyester compositions may further include a transesterification inhibitor to control the likelihood of transesterification occurring between the rheology modifier and the polyester.

### BRIEF DESCRIPTION OF THE DRAWINGS

FIG. 1 illustrates the stress-strain data for unmodified PET resin and for a blend of PET resin with 0.25 wt. % third generation dendrimer modifier at 100° C.

FIG. 2 illustrates the melt viscosity of a PET resin at levels of 0.25 wt. % and 0.50 wt. % dendrimer modifier over a range of shear rates.

FIG. 3 illustrates the crystallinity development in resins with and without hyperbranched polymers.

FIG. 4 illustrates the viscosity variation with shear rate for resins with and without hyperbranched polymers.

FIG. 5 illustrates the rheology of PET/Hyperbranched composition at 280° C.

### DETAILED DESCRIPTION OF THE INVENTION

Crystallizable polyester resins suitable for use as the thermoplastic component of the invented compositions include any of the widely known and available polyester packaging resins. Resins that comprise ethylene terephthalate, ethylene naphthalate, butylene terephthalate and the like will be particularly suitable for this use. Copolymer resins comprising polyethylene terephthalate wherein a minor proportion of the ethylene terephthalate units are replaced by compatible monomer units will be preferred. For example, the ethylene glycol moiety may be replaced by aliphatic or alicyclic glycols such as cyclohexane dimethanol (CHDM), trimethylene glycol, polytetramethylene glycol, hexamethylene glycol, dodecamethylene glycol, diethylene glycol, polyethylene glycol, polypropylene glycol, propane-1,3-diol, butane-1,4-diol, and neopentyl glycol, or by a bisphenol and other aromatic diol such as hydroquinone and 2,2-bis (4′-β-hydroxyethoxyphenyl) propane. Examples of dicarboxylic acid moieties which may be substituted into the monomer unit include aromatic dicarboxylic acids such as isophthalic acid (IPA), phthalic acid, naphthalene dicarboxylic acid, diphenyl dicarboxylic acid, diphenoxyethane dicarboxylic acids, bibenzoic acid, and the like, as well as aliphatic or alicyclic dicarboxylic acids such as adipic acid, sebacic acid, azelaic acid, decane dicarboxylic acid, cyclohexane dicarboxylic acid, and the like. Copolymers comprising various multifunctional compounds such as trimethylolpropane, pentaerythritol, trimellitic acid and trimesic acid copolymerized with the polyethylene terephthalate may also be found suitable.

PET resins comprising up to about 20 wt. % ethylene isophthalate units or ethylene naphthalate units may be useful in the manufacture of packaging materials and containers. Polynapthalate resins comprising up to about 20 wt. % ethylene isophthalate units or ethylene terephthalate units may also be found useful in similar applications. It will be understood that selection of particular comonomer units and the amounts employed will depend in part upon the effect on resin properties including crystallinity. For most applications, the amount of comonomer will preferably be no more than about 15 mole %, more preferably no more than about 10 mole %. Although copolymers comprising greater amounts of comonomer, as great as 50 mole %, may be found useful, high levels of comonomer generally tend to interfere with crystallization and thus will not be preferred.

The terms PET and polyethylene terephthalate as used herein interchangeably are intended to mean polyethylene terephthalate homopolymer; the terms PET resin and polyethylene terephthalate resin, as used interchangeably herein, are intended to mean PET copolymer. Though described as PET homopolymers, those obtained from commercial sources are generally PET resins that comprise minor amounts, typically no more than about 3 mole % ethylene isophthalate. PETI resins are ethylene terephthalate-ethylene isophthalate copolymer resins; PETN resins are ethylene terephthalate-ethylene naphthalate copolymer resins; and PENT resins are ethylene napthalate-ethylene terephthalate copolymer resins.

Polyester resins, as well as methods for their preparation, are well known in the art. A wide variety of such resins are readily available from commercial sources in several forms including sheet, film, and the like, and as powdered or pelletized resins in a variety of grades such as extrusion grades, fiber grades, molding grades, coating grades, and the like, including grades particularly intended for use in making containers. The PET resins may further comprise compatible additives such as, for example, those additives commonly employed in the container and packaging materials arts, including thermal stabilizers, light stabilizers, dyes, pigments, plasticizers, fillers, antioxidants, lubricants, extrusion aids, residual monomer scavengers, and the like.

PET resins having an intrinsic viscosity (i.v.) in the range of from about 0.55 to about 1.04, preferably from about 0.65 to 0.95 dl/g, will be suitable for use in the practice of this invention. PET resins having an intrinsic viscosity of about 0.8 dl/g are widely used in the packaging industry in a variety of container applications. As used herein, the intrinsic viscosity will be determined according to the procedure of ASTM D-2857, at a concentration of 5.0 mg/ml in a solvent comprising o-chlorophenol, respectively, at 30° C.

The invented compositions will further comprise at least one dendrimeric modifier, in an amount sufficient to modify the strain-hardening parameter of the polyester resin. Dendrimers, also known as cascade polymers, are discrete, highly branched, monodisperse oligomers or polymers that possess branching patterns reminiscent of trees. Physically, dendrimer molecules have been described as three-dimensional globular structures having a core, a number of branching generations and an external surface composed of end groups. Dendrimers and hyperbranched polymers suitable for use in this invention are well defined, highly branched macromolecules that radiate from a central core and are synthesized through a stepwise repetitive branching reaction sequence. The structural units may either be the same for each successive generation, or they may be different. The structural units are bound radially to the core or to the structural units of a previous generation and extend outwards. The repetitive branching sequence provides complete shells for each generation, leading to polymers that are typically monodisperse.

Dendrimers may be characterized on the basis of a degree of branching. The term “degree of branching” as used in connection with dendrimers is understood to mean the ratio between the number of branchings present and the maximum possible number of branchings in a completely branched dendrimer of the same generation. The term “functional end groups” as used in connection with dendrimers refers to those reactive groups that form part of the external surface of a dendrimer. The branchings may occur with greater or lesser regularity. The branchings at the external surface of the dendrimer may all be of the same generation or of different generations.

The term dendrimer will also be understood to include dendrimers having defects in the branching structure, dendrimers having an incomplete degree of branching, asymmetrically branched dendrimers, star polymers, highly branched or hyperbranched polymers and copolymers, and copolymers comprising highly branched and not highly branched polymers. Particularly preferred are star or starburst dendritic polymers.

Dendrimers and methods for their preparation are well known in the art, and are described, for example, in U.S. Pat. Nos. 5,530,092; 5,530,092; 5,998,565; 5,418,301 and 5,663,247. Commercially available dendrimers which may be found suitable for use in the practice of this invention include highly branched, polyfunctional polyesters with hydroxyl functionality, obtainable as Boltorn® dendrimers from Perstorp Specialty Chemicals; Astramol poly(propylene imine) dendrimers and Hybrane hyperbranched polyesteramides, obtainable from DSM corporation; and starburst polyamine dendrimers, obtainable from Aldrich Chemical Company.

The amount of dendrimeric modifier that will be included in the invented composition will be sufficient to reduce the strain level at which strain hardening occurs. The amount of reduction will be determined in part by the intended use or fabrication method that will be employed. In applications where the resin being modified is a PET copolyester packaging resin, the amount will desirably be selected to be sufficient to reduce the strain level to that of a packaging grade PET homopolymer. The compositions will preferably comprise up to about 2 wt. %, more preferably up to about 1 wt. % of at least one dendrimer. More particularly, the amount of modifier employed will generally lie in the range of from about 0.001 to about 2 wt. %, based on total weight of resin components. An amount of modifier of from about 0.01 to about 2 wt. %, more preferably from about 0.01 to about 1.5 wt. %, still more preferably from about 0.01 to about 1.0 wt. %, based on total weight of resin components, will be found sufficient for most applications. For many applications, compositions comprising amounts of modifier of from about 0.01 to about 0.5 wt. % based on combined weight of polyester and modifier will be found particularly useful. It will be understood that the use of conventional fillers, reinforcement, processing aids and the like may further determine the level of modifier that will be required to obtain the desired reduction in strain-hardening.

Dendrimers are disclosed in the art for use as rheology modifiers to reduce the melt viscosity of resin compositions. Polyester compositions, according to this invention, that comprise greater than about 2 wt. % dendrimer, based on combined weight of polyester and dendrimer, have very high melt-flow and are generally unprocessable using conventional extrusion or molding equipment. Levels greater than about 2 wt. % thus are not preferred.

As with other polyfunctional additives, dendrimers may react with the polyester through transesterification, substantially increasing the resin molecular weight and possibly thermosetting the composition through crosslinking. It may thus be desirable to minimize the potential for transesterification by avoiding exposure to high temperatures for significant periods of time during thermal fabrication, for example, using extrusion and blow molding operations. It may also be desirable to further include in the composition an effective amount of a transesterification inhibitor. A variety of phosphites such as, for example, bis (2,4-di-t-butylphenyl) pentaerythritol diphosphite, sold as Ultranox 626 by GE, are known to be useful for this purpose, and are readily available from commercial sources. The inhibitor will be included in an amount sufficient to inhibit or control transesterification, generally from about 0.5 to about 5 wt. % based on the combined weight of polymer components.

The invention described herein will be better understood by consideration of the following examples, which are offered by way of illustration and not intended to be limiting.

### EXAMPLES

The resins used in the following examples include:

PET-1: Polyethylene terephthalate resin, fiber grade, with an i.v. =0.57 dl/g, from BP.

PET-2: Polyethylene terephthalate resin with an i.v.=0.75 dl/g, obtained from Shell M&G as Resin 7207.

PET-3: Polyethylene terephthalate resin with an i.v.=0.80 dl/g, obtained from Shell M&G as Resin 8416.

PET-4: Polyethylene terephthalate resin with an i.v.=0.92 dl/g, obtained from Shell M&G as Resin 1006.

PETI-10: Polyethylene terephthalate-isophthalate copolymer resin containing 10 mole % ethylene isophthalate units, with an i.v.=0.73 dl/g, obtained from Kosa as 3303.

PETN-10: Polyethylene terephthalate-naphthalate copolymer resin containing 10 mole % ethylene naphthalate units, with an i.v.=0.71 dl/g, obtained from Shell M&G as Resin 6017.

PENT-10: Polyethylene naphthalate-terephthalate copolymer resin containing 10 mole % ethylene terephthalate units, with an iv=0.74 dl/g, obtained from Hoechst as FK628.

Dend-2: Second generation dendritic polyester with theoretically 16 primary hydroxyl groups and a molecular weight of 1747, obtained as Boltorn® H₂O, from Perstorp.

Dend-3: Third generation dendritic polyester with theoretically 32 primary hydroxyl groups and a molecular weight of 3604 g/mole, obtained as BOLTORN® H30, from Perstorp.

Dend4: Fourth generation dendritic polyester with theoretically 64 primary hydroxyl end groups and a molecular weight of 7316 g/mole, obtained as BOLTORN® H40 from Perstorp.

Dend-5: Fifth generation dendritic polyester, obtained from Perstorp.

Dend-6: Hyperbranched polyesteramide modifier, obtained as Hybrane P1000 from DSM.

Stress-strain data were obtained at different temperatures using an Instron tensile tester fitted with a conditioning chamber, substantially following the procedures of ASTM—D882-97. For the purposes of this invention, stress-strain data will preferably be obtained at a temperature greater than the resin Tg. More particularly, the temperature will be at or above the temperatures generally employed for fabricating the resin, for example, by stretch blow molding, in the production of oriented, crystalline articles. Still more particularly, the test temperature will preferably lie in the range of from 20° C. above the resin Tg to 20° C. less than the resin Tm.

PET stress-strain curves typically comprise a plurality of segments. Initially, the stress-strain line rises almost linearly to the yield point—the stress level where the specimen begins to yield. After the yield point, the test specimen extends through chain unfolding and alignment, orienting over a range of strains without substantial increase in stress level until reaching the strain-hardening region. Further extension initiates crystallization in the oriented chains, causing a rapid increase in stress with increase in strain.

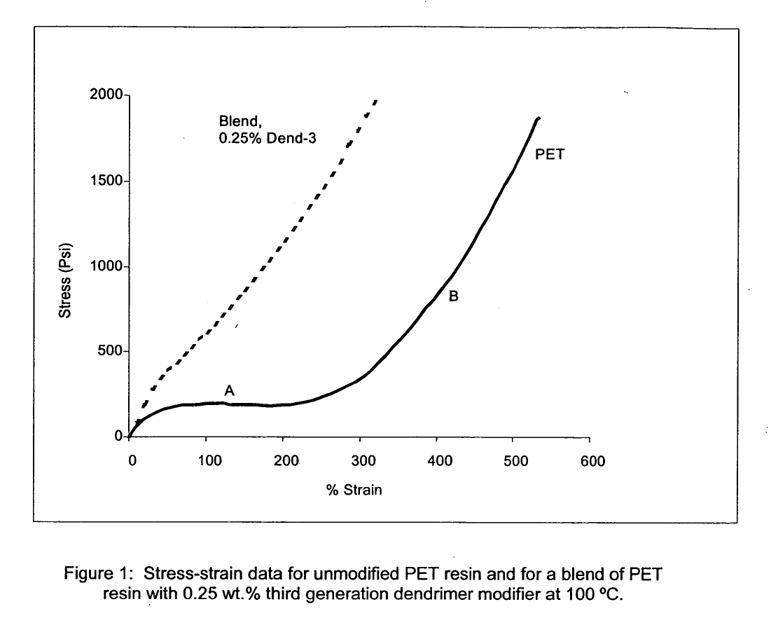

Turning to the graphic presentation, FIG. 1 shows a stress vs. strain plot of data obtained in tensile testing at 100° C. of a PET resin test specimen. In the portion of the data plot identified as A, the stress level is seen to remain substantially constant as the specimen is extended, becoming oriented as it extends. Strain hardening begins at a stress level of about 340%, where orienting is substantially complete. The stress level rises rapidly as the specimen is further extended to the point where the specimen breaks, corresponding to the portion of the data plot identified as B.

Referring to the stress vs. strain plot of data obtained in tensile testing at 100° C. of a test specimen consisting of a blend of PET resin with 0.25 wt. % third generation dendrimer, also shown in FIG. 1, it will be seen that the yield portion of the curve has been dramatically shortened, the strain hardening portion of the curve now beginning at a stress level of about 120%, substantially lower than found for the unmodified resin specimen.

Different methods have been suggested in the literature to determine the point at which strain hardening occurs, i.e., the strain-hardening parameter (SHP). In the following examples, the strain-hardening parameter is determined by the point after which an almost linear stress-strain line can be drawn, as is illustrated by the two stress-strain curves presented in FIG. 1.

However, as will be seen in FIG. 1, and further demonstrated in the following examples, the effect of a dendrimeric modifier on resin strain-hardening parameter is so dramatic that the effect will be readily apparent irrespective of the method used.

PET and compositions comprising PET and small amounts of hyperbranched polymer were compounded in a 1.25 inch Brabender twin-screw extruder having a 2 oz. barrel and fitted with a general purpose screw. The barrel operating temperatures, selected based on resin processing characteristics, were in the range of 260° C. to 290° C. The chopped extruded strand was dried at 250° C. overnight, then extruded into 20 mil thick sheet, using a 1.25 inch Killion extruder fitted with a 6 inch sheet extrusion die, using barrel temperatures in the range of from 500° F. to 560° F. and die temperatures of from 495° F. to 535° F., selected depending upon resin IV and composition according to practices generally used in the extrusion arts.

Test strips, 0.5″ by 6.5″, were cut from the extruded sheet and conditioned at 23° C. and 50% relative humidity for at least 40 hrs. Stress-strain data were obtained at the selected test temperature, using an Instron tensile tester fitted with a conditioning chamber, as described.

### Control Examples C1-C7

Test specimens formed from PET polymers having different molecular weights and from PET copolymers were tested substantially as outlined above; the strain levels at 100° C. are summarized in the following Table 1.

TABLE 1
Effect of Resin i.v. on Strain-hardening of PET at 100° C.

| Ex. | | i.v. | Strain |
|---|---|---|---|
| No. | Resin | dl/g | (%) |
| C1 | PET-1 | 0.57 | n.d. |
| C2 | PET-2 | 0.75 | 417 |
| C3 | PET-3 | 0.80 | 345 |
| C4 | PET-4 | 0.92 | 302 |
| C5 | PETI-10 | 0.73 | 420 |
| C6 | PETN-10 | 0.71 | 478 |
| C7 | PENT-10 | 0.74 | 536 |

It will be seen that increasing the resin molecular weight—as reflected in the PET i.v. values of Examples C1-C4—reduces the strain level at the point at which strain hardening takes place; the strain-hardening parameter or SHP.

Including a comonomer will be seen to significantly increase SHP; a PET copolymer comprising 10% ethylene isophthalate units, Example C5, and copolymers comprising 10% ethylene naphthalate units, Example C6, and 90% ethylene napthalate units, Example C7, had much higher SHP values than PET homopolymers.

### Examples 1-7

PET resin compositions comprising PET4 and varying amounts of each of two dendrimeric modifiers were compounded substantially as described for the Control Examples C1-C6 to provide test specimens for Examples 1-6. Control examples comprising PET-4 without modifier, C4, were similarly compounded and tested for comparison purposes. The test specimens were conditioned and tested as described. The strain levels obtained for the test specimens at 100° C. are summarized in the following Table 2.

TABLE 2
Strain-hardening of PET Resin Compositions at 100° C.

| Ex. | | | | Strain |
|---|---|---|---|---|
| No. | PET resin | Additive | (wt. %) | (%) |
| C4 | PET-4 | None | (0) | 302 |
| 1 | PET-4 | Dend-4 | (0.05) | 220 |
| 2 | PET-4 | Dend-4 | (0.15) | 112 |
| 3 | PET-4 | Dend-4 | (0.25) | 138 |
| 4 | PET-4 | Dend-4 | (0.5) | 133 |
| 5 | PET-4 | Dend-5 | (0.25) | 116 |
| 6 | PET-4 | Dend-5 | (0.5) | 116 |

It will be seen that the strain-hardening parameter, as reflected in the % strain level, is reduced by adding as little as 0.05 wt. % of the hyperbranched polymer dendrimeric modifier (Example 1). SHP is not substantially affected by further increasing the level of dendrimeric modifier above 0.25 wt. %; compare Example 3 with 4 and Example 5 with 6.

As noted above, SHP as reflected in strain level is significantly higher for PET copolymers. In addition, because crystallization rates are lower, PET copolymers may require processing at elevated temperatures, further increasing strain level and thereby SHP.

In the following Example 7, a blend comprising a polyethylene terephthalate-isophthalate copolymer, PETI-10, and 0.25 wt. % dendrimeric modifier, Dend-2, was extruded into sheet as described for Example 1-6, and tested at 100° C. and at 110° C. The data are summarized in the following Table 3.

TABLE 3
Strain-hardening of PETI-10 Resin Compositions

| Ex. | | | | Strain (%) at | |
|---|---|---|---|---|---|
| No. | Resin | Additive | (wt. %) | 100° C. | 110° C. |
| C5 | PETI-10 | None | (0) | 420 | 566 |
| 7 | PETI-10 | Dend-2 | (0.25) | 407 | 254 |

As will be seen from a comparison of the strain data for Example 7 with C5, adding dendrimer reduced SHP at the elevated temperature for the PETI-10 blend at 110° C. close to that for PET at 100° C. See strain level for control example C4, presented in Table 2. Similarly, adding dendrimer to PETN-10 substantially lowered SHP at both temperatures.

Crystallinity levels and transition temperatures were determined for specimens of Examples 3 and 4, and of Control Example C4, stretched at 100° C. as described above, with a TA Instruments model 2980 differential scanning calorimeter (DSC), using a heating rate of 10° C./min. The data are summarized in the following Table 4. The degree of crystallinity was obtained by assuming a delta H of fusion, ΔH_{f}, of 120 j/g.

TABLE 4
DSC Data for PET Resin Compositions

| | | | DSC | | | | | |
|---|---|---|---|---|---|---|---|---|
| Ex. | | | Tg | Tc | Δ Hc | Tm | Δ Hc | Cryst. |
| No. | Additive | (wt. %) | (° C.) | (° C.) | j/g | (° C.) | j/g | % |
| C4 | None | (0) | 85 | 118 | 6.6 | 251 | 50.3 | 33 |
| 3 | Dend-4 | (0.25) | 81 | 120 | 5.2 | 250 | 45.2 | 30 |
| 4 | Dend-4 | (0.5) | 76 | 115 | 10.2 | 251 | 49.5 | 30 |

It will be seen that the presence of dendrimeric modifier had little effect on the degree of crystallinity in a PET resin. However, even these low levels of the dendritic modifier lowered the Tg.

### Example 8

A composition comprising 3 wt. % of Dend-5 dendrimer was blended with PET-4 copolyester by compounding in a twin screw extruder, as described. No sheet extrusion product could be made; the composition melt viscosity had been reduced to a level where the melt drooled out of the die-head and did not have sufficient melt strength for stranding.

### Examples 9-12

Compositions comprising PETN-10 and 0.25 wt. % of various dendrimers were compounded to provide test specimens substantially as described for Examples 1-6. A control example, C6, comprising PETN-10 without dendrimer was similarly compounded and formed for comparison purposes.

### Example 13

A composition comprising PENT-10 and 0.25 wt. % of a second generation Boltorn® dendrimer was compounded to provide test specimens substantially as described for Examples 1-6. A control example, C7, comprising PENT-10 without dendrimer was similarly compounded and formed for comparison purposes.

The test specimens for Examples 9-12 and control examples C6 and C7 were conditioned and tested as described hereinabove. The compositions and the strain and modulus properties of the test specimens at 100° C. are summarized in the following Table 5.

TABLE 5
Strain-hardening of Polyethylene Naphthalate-terephthalate
Resins at 100° C.

| Ex. | | | | Strain |
|---|---|---|---|---|
| No. | Resin | Additive | wt. % | (%) |
| C6 | PETN-10 | none | 0 | 478 |
| 9 | PETN-10 | Dend-2 | 0.25 | 390 |
| 10 | PETN-10 | Dend-3 | 0.25 | 451 |
| 11 | PETN-10 | Dend-4 | 0.25 | 309 |
| 12 | PETN-10 | Dend-6 | 0.25 | 291 |
| C7 | PENT-10 | None | 0 | 536 |
| 13 | PENT-10 | Dend-2 | 0.25 | 254 |

It will be apparent from the strain data for Examples 9-12 that including dendrimeric modifier in polyethylene terephthalate-naphthalate copolymers substanstially reduces SHP as reflected by the reduction in strain level. The effect on SHP extends to more rigid polymers, as seen in the reduced strain level for a polyethylene naphthalate-terephthalate resin when modified with dendrimer, Example 12.

Stree-strain data values for the blends of Examples 9-11 and 13 and the corresponding control resins C₆-C₇, determined at temperatures of from 90° C. to 120° C., are summarized in the following Table 6.

TABLE 6
Strain-hardening of Polyethylene Naphthalate-terephthalate Resins
with Dendrimers - Effect of Temperature on Strain Level

| Ex. | | Addi- | | Strain (%) at | | | |
|---|---|---|---|---|---|---|---|
| No. | Resin | tive | wt. % | 90° C. | 100° C. | 110° C. | 120° C. |
| C6 | PETN-10 | none | 0 | 474 | 478 | >500 | >500 |
| 9 | PETN-10 | Dend-2 | 0.25 | 426 | 390 | 430 | 299 |
| 10 | PETN-10 | Dend-3 | 0.25 | 484 | 451 | 437 | 409 |
| 11 | PETN-10 | Dend-4 | 0.25 | 381 | 309 | 465 | 243 |
| C7 | PENT-10 | None | 0 | 553 | 536 | 408 | n.d. |
| 13 | PENT-10 | Dend-2 | 0.25 | 283 | 254 | 243 | n.d. |

It will be seen that increased temperature does not detrimentally affect performance of the blends. The strain levels of the blends are effectively modified by these low levels of dendrimer at elevated temperatures as great as 120° C.

The effect of dendrimer additives on melt rheology of PET resin was determined using a Galaxy 5 Kayness capillary rheometer fitted with a 1 mm capillary, 30 mm in length. Compositions comprising PET4 compounded with 0.25 wt. %, Example 3, and with 0.5 wt. % Dend4 modifier, Example 4, and a sample of PET4, C4, were dried overnight at 120° C., then introduced into the capillary rheometer. The melt viscosities, determined at 285° C. for shear levels of from 10 to 1000 sec⁻¹, are summarized in the following Table 7.

TABLE 7
Melt Viscosity of PET resin - Dendrimer Blends

| | | Melt viscosity (Pa-s) | | | | | |
|---|---|---|---|---|---|---|---|
| Ex. | Dend-4 | at shear level (sec⁻¹): | | | | | |
| No. | (wt. %) | 10 | 50 | 100 | 200 | 500 | 1000 |
| C4 | none | 506.7 | 469.0 | 428.9 | 379.3 | 306.1 | 227.9 |
| 3 | 0.25 | 568.2 | 465.2 | 405.2 | 342.0 | 260.4 | 204.3 |
| 4 | 0.5 | 676.6 | 482.8 | 401.8 | 326.8 | 240.0 | 185.0 |

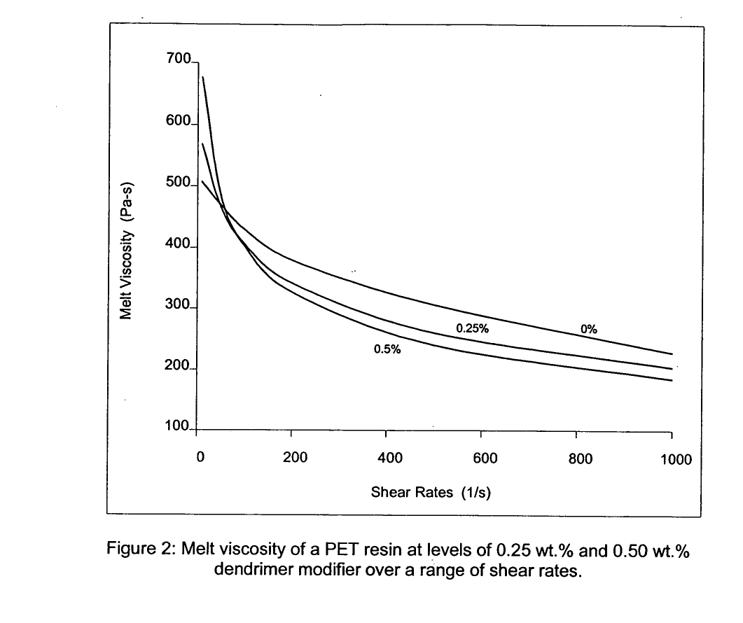

The effect of dendrimer additives on PET melt rheology is further shown in FIG. 2. It will be apparent that there is an increase in low shear melt viscosity of the resin, while at high shear the melt viscosity is reduced.

The increase in low shear melt viscosity of the blend compositions is remarkable. Resins exhibiting high melt viscosity at low shear generally will exhibit less tendency to drool when fabricated in molding and extrusion machines, as well as good melt strength. The reduction in melt viscosity at higher shear levels may improve the resin melt processing characteristics, particularly for use in profile extrusion and screw injection molding equipment. PET resins compounded with reactive multifunctional additives such as, for example, pyromellitic acid dianhydride and the like, generally are observed to have substantially increased melt viscosity at all shear levels and become more difficult to fabricate.

Melt strength is an important parameter in determining suitability of particular melt processing methods for fabricating a resin. For example, low melt strength resins are not easily fabricated by extrusion, particularly in film and extrusion blow molding processes and in profile and sheet extrusion operations where the extrudate exiting the die is unsupported. It is known that melt strength may be improved by increasing resin molecular weight, or by introducing multifunctional cross-linking additives. These prior art methods tend to detrimentally affect resin processability by raising melt viscosity, thereby requiring higher processing temperatures.

Die swell, the increase in size of a melt stream when exiting the constraints of an extruder die, is another measure of resin melt rheology. Increase in die swell reflects an increase in resin melt elasticity, a parameter related to melt strength. Die swell values for the rheology specimens above, summarized in Table 8, were determined by measuring the diameter of the extruded resin strand emerging from the rheometer capillary. The strand diameters (dia.) are summarized in the following Table 8; die swell as % of capillary diameter (1 mm or 40 mil) is also presented.

TABLE 8
Die Swell for PET Resin - Dendrimer Blends

| Ex. | | | dia. | Die |
|---|---|---|---|---|
| No. | Additive | (wt. %) | (mils) | swell |
| C4 | None | (0) | 35 | 88% |
| 3 | Dend-4 | (0.25) | 50 | 126% |
| 4 | Dend-4 | (0.5) | 75 | 190% |

The low melt strength and elasticity of uncompounded PET resin resulted in a reduction in strand diameter when extruding PET resin without dendrimer additive; see control example C4. The substantial die swell observed for the extrudates of Examples 3 and 4 reflects the considerable increase in melt strength obtained by blending PET with dendrimer.

In addition to the examples shown above where PET and the hyper-branched polymers were compounded in a standard single or double screw extruders, the polyester/hyper-branched polymers compositions were also made using a reactor route. In the following examples, the hyper-branched polymer was added during the melt polymerization of the polyester. The addition was done either along with the initial charge of reactants (i.e. in the esterification/condensation step) or in the poly-condensation step.

In all examples below, G2 designates the second generation hyper-branched polymer sold commercially as Boltorn® H-20. The noted percentage refers to the ratio of G2/purified terephthalic acid (PTA). Thus, PET w/0.16% G2 denotes the PET composition in which 0.0016 grams of G2 were added per 1 gram of PTA. This translates to 0.00138 grams of G2 per gram of polymer. Compositions containing various levels of G2 were synthesized. The examples below show that only small levels of a hyperbranched polymer are sufficient to make substantial change in the resins' properties and the articles made from that resin.

### Example 14

A 2 liter batch reactor was used to make a PET resin with 0.16% G2. The first step is esterification followed by a polycondensation step which is done under vacuum. A series of turn-downs are conducted whereby the RPM of the reactor is reduced at specific times signaled by a certain torque reading. The torque reading translates into viscosity which is related to the molecular weight. In this example, the G2 amount was added after the last turn-down characteristic of a typical “standard” PET preparation. Before adding G2, vacuum was relieved. The G2 was added within few seconds. The reactor was resealed and purged, and vacuum was reapplied at 30 mmHg/min. The agitator torque fell slightly, but built rapidly as vacuum levels dropped. The agitator speed was reduced twice to maintain torque levels in the usual range. Once the vacuum reached 1 mmHg, the reaction continued for 5 minutes before being terminated. Material had very little build up of static electricity during the chopping of the polymer strand.

### Example 15

The standard procedure for making PET was followed (PET control). At the normal ending point of the run, vacuum was relieved and a G2 addition was simulated, but the exposure time was reduced to 30 seconds to minimize exposure to air. The reactor was resealed and purged, and vacuum was reapplied at 45 mmHg/min (as opposed to 30 mmHg/min). After the simulated addition, the agitator torque fell slightly, but built rapidly as vacuum levels dropped. The agitator speed was reduced twice to maintain torque levels in the usual range. Once the vacuum reached 1 mmHg, the reaction continued for 5 minutes before being terminated. Material had the usual build up of static electricity during the chopping of the polymer strand.

### Example 16

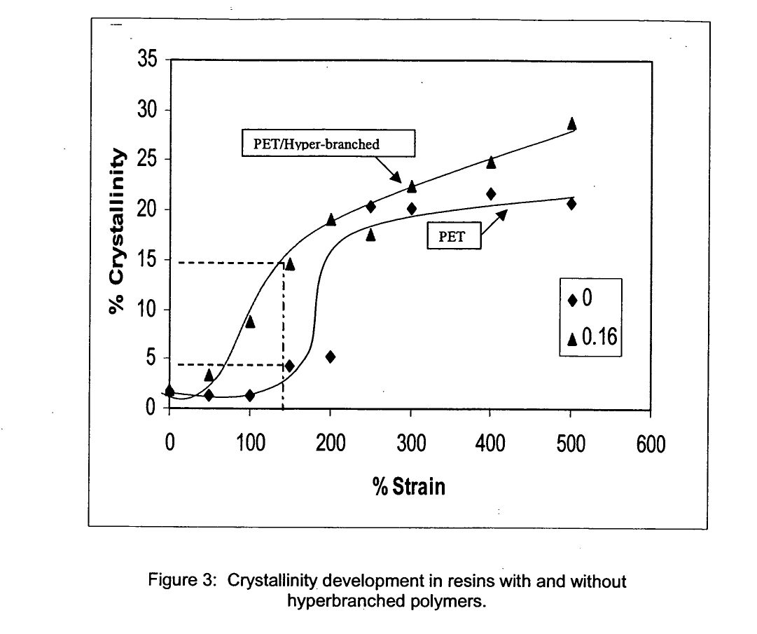

The resins prepared in examples 14 and 15 were solid-stated and extruded into sheets as described earlier. Test specimens were cut from the amorphous sheet. The stress-strain curves were determined at 100° C. as described earlier. Furthermore, the crystallinity developed at different strains was obtained. The data was obtained by subjecting a given sample to a certain strain of about 100%. Then the sample was taken and its density was determined. From the density, the degree of crystallinity was calculated. FIG. 3 shows that the crystallinity of the sheet made from the composition having the hyperbranched polymer builds up much faster than a typical PET resin. For example, at a stain of about 150%, PET will have a degree of crystallinity of about 4% whereas the PET/hyperbranched composition has a degree of crystallinity over 14%.

### Example 17

PET with and without hyperbranched resins were scaled up and 80-pound batches were obtained from a pilot plant reactor. The resin MMP-212 is a typical PET packaging resin and MMP-225 is a composition where H-20 was added in the reactor at a level of 0.15%. Thus these two compositions are almost the same as in examples 14-16. Sheets were made from both compositions and the strain-hardening parameter was determined at 100° C. Table 7 shows the results.

TABLE 7
Stress and strains at the Strain-hardening point at
a temperature of 100° C.

| Resin | Modulus | Stress | % Strain |
|---|---|---|---|
| MMP-212 | 556 | 470 | 505 |
| MMP-225 | 1461 | 1520 | 347 |

This table shows that the composition with the hyperbranched polymer strain-hardens faster that PET. The MMP-225 composition was subjected to intermediate strain experiment as discussed in the previous example. At a strain of 150%, the crystallinity build-up was 13.3% vs. 4% for the PET resin.

### Example 18

Compositions made with and without G2 were subjected to rheology measurements using a capillary rheometer. Consistent with our expectations, the compositions containing G2 behave similar to branched systems.

(a) The zero-shear-rate viscosity is significantly increased.

(b) Shear thinning behavior is observed.

(c) Die swell becomes more pronounced.

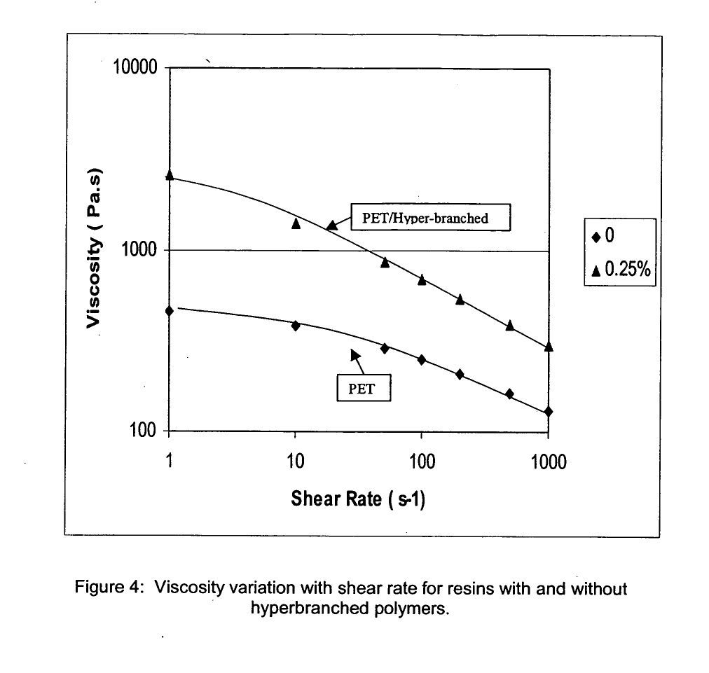

A representative data is shown in FIG. 4 where a plot of the viscosity/shear rate for PET and PET/hyperbranched composition is given. The points under (a) and (b) above are clearly demonstrated. For example, at a shear rate of approximately 1 s-1, the viscosity of a standard PET resin is 450 Pa.s whereas as the PET/hyper-branched composition has a viscosity greater than 2600 Pa.s which is over a five fold increase. Moreover, if one considers the slope of the viscosity/shear rate curve as a proxy for shear thinning, one finds that for PET, the slope is −0.27 whereas for the PET/hyper-branched composition the slope is −0.35, indicating a higher shear thinning. In other words, the power law exponent is 0.73 and 0.65, respectively, for the PET and PET/hyper-branched resin. This data was generated at 280° C. Other temperatures and other compositions were run and similar results were obtained. To illustrate the die swell which is related to the elasticity of the compositions, Table 8 is presented. Here the diameter refers to the diameter of the strand as it issues from the capillary rheometer.

TABLE 8
Elasticity of different compositions

| % Hyperbranched polymer | Diameter (mm) |
|---|---|
| 0 | 1.13 |
| 0.25% | 2.23 |

### Example 19

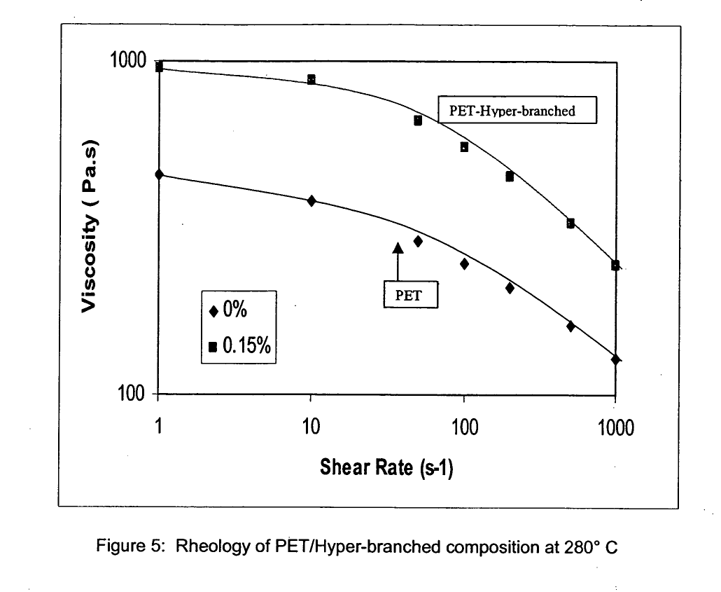

The composition of example 14 was produced again. The difference in this example is that the hyperbranched polymer with added during the initial charge of the reactants. The melt polymerization run proceeded with no issues in either the esterification or the polycondensation steps. The resulting composition was solid-stated and its rheology was determined. FIG. 5 shows the viscosity/shear rate data for this composition relative to a standard PET resin. Taking the viscosity at a shear rate of 1 s-1, one finds that the PET/hyper-branched composition has a viscosity of over 950 Pa.s. Recall that the PET viscosity at the same shear rate was 450 Pa.s., thus over a two-fold increase in the viscosity was observed. Additionally, the diameter of the issuing strand of polymer from the rheometer was increased to 1.55 mm vs. 1.13 mm for the PET composition. Thus, the composition of this example behaves similar to that of example 17 in terms of its viscous behavior (an increase in the zero-shear-rate viscosity) and elasticity behavior (die swell). We have also shown that the composition of example 17 strain-hardens faster that a typical PET packaging resin.

While the invention has been illustrated by means of specific embodiments, these are not intended to be limiting. The invented compositions having modified melt rheology, melt strength and fabrication parameters as described herein are illustrated in terms of particular PET resins and dendrimeric modifiers. Those skilled in the compounding and fabricating arts will understand that the invented polyester compositions may comprise a plurality of such polyester resins, and may further comprise such additional components including reinforcement, fillers, dyes, pigments, thermal and light stabilizers, flame retardants, processing aids, and the like as are commonly employed in the resin compounding arts. It will also be recognized that the methods described herein may be found suitable for modifying melt rheology and fabrication parameters of a wide variety of crystallizable thermoplastics, including olefin polymers such as polypropylene, as well as polycarbonates, polyamides, polyester amides, and the like. Dendrimer-modified compositions comprising low levels of dendrimers and such thermoplastics are thus also considered part of this invention.

These and still further additions and modifications will be readily apparent to those skilled in the art, and such modifications and additions, as well as compositions, formulations and articles embodying them, are contemplated to lie within the scope of the invention, which is defined and set forth in the following claims.

What is claimed is:

1. A composition comprising a crystallizable thermoplastic resin and up to about 2 wt. %, based on total weight of resin components, of a dendrimer modifier.

2. The composition of claim 1 wherein said thermoplastic is a crystallizable polyester.

3. A composition comprising crystallizable polyester resin and from about 0.001 to about 2 wt. %, based on total weight of resin components, of a dendrimer modifier.

4. The composition of claim 3 comprising from about 0.01 to about 1 wt. % of said modifier.

5. The composition of claim 3 comprising from about 0.01 to about 0.5 wt. % of said modifier.

6. The composition of claim 3 wherein said polyester resin is selected from polyethylene terephthalate, polyethylene naphthalate, copolymers comprising ethylene terephthalate and ethylene isophthalate, and copolymers comprising ethylene naphthalate and ethylene terephthalate.

7. The composition of claim 3 wherein said polyester is an ethylene terephthalate-ethylene isophthalate copolymer.

8. The composition of claim 3 wherein said polyester is an ethylene terephthalate-ethylene isophthalate copolymer comprising up to about 10 mole % ethylene isophthalate units.

9. A method for lowering the strain-hardening parameter of a thermoplastic polyester, said method comprising compounding said polyester with up to about 2 wt. %, based on total weight of resin components, of a dendrimer modifier.

10. The method of claim 9 wherein said polyester is compounded with from about 0.01 to about 2 wt. % of said modifier.

11. The method of claim 9 wherein said polyester is compounded with from about 0.01 to about 1 wt. % of said modifier.

12. The method of claim 9 wherein said polyester is compounded with from about 0.01 to about 0.5 wt. % of said modifier.

13. The method of claim 9 wherein said polyester resin is selected from polyethylene terephthalate, polyethylene naphthalate, copolymers comprising ethylene terephthalate and ethylene isophthalate, and copolymers comprising ethylene naphthalate and ethylene terephthalate.

14. A method for improving the melt strength of a crystallizable thermoplastic, said method comprising compounding said polyester with up to about 2 wt. %, based on total weight of resin components, of a dendrimer modifier.

15. The method of claim 14 wherein said thermoplastic is compounded with from about 0.01 to about 2 wt. % of said modifier.

16. A method for improving the melt strength of a crystallizable polyester, said method comprising compounding said polyester with up to about 2 wt. %, based on total weight of resin components, of a dendrimer modifier.

17. The method of claim 16 wherein said polyester is compounded with from about 0.01 to about 2 wt. % of said modifier.

18. The method of claim 16 wherein said polyester is compounded with from about 0.01 to about 1 wt. % of said modifier.

19. The method of claim 16 wherein said polyester is compounded with from about 0.01 to about 0.5 wt. % of said modifier.

20. The method of claim 16 wherein said polyester resin is selected from polyethylene terephthalate, polyethylene naphthalate, copolymers comprising ethylene terephthalate and ethylene isophthalate, and copolymers comprising ethylene naphthalate and ethylene terephthalate.

21. A method for lowering the strain hardening parameter of a thermoplastic polyester, said method comprising reacting said polyester with a dendrimer modifier added during the melt polymerization of the polyester.

22. The method of claim 21, wherein the addition of the dendrimer modifier is done in an esterification step.

23. The method of claim 21 wherein the addition of the dendrimer modifier is done in a polycondensation step.

24. The method of claim 21 wherein said polyester is selected from polyethylene terephthalate, polyethylene naphthalate, copolymers comprising ethylene terephthalate and ethylene isophthalate, and copolymers comprising ethylene naphthalate and ethylene terephthalate.

25. A composition comprising a crystallizable polyester resin and a component comprising a ratio of dendrimer modifier to purified terephthalic acid.

26. The composition of claim 25 wherein the ratio comprises up to about 0.1 parts dendrimer modifier per up to about 1 part purified terephthalic acid.

27. The composition of claim 25 wherein said polyester resin is selected from polyethylene terephthalate, polyethylene naphthalate, copolymers comprising ethylene terephthalate and ethylene isophthalate, and copolymers comprising ethylene naphthalate and ethylene terephthalate.
